(19) United States
(12) Patent Application Publication
(10) Pub. No.: US 2021/0280133 A1
(43) Pub. Date: Sep. 9, 2021

(54) IMAGE PROCESSING METHOD OF DISPLAY PANEL AND DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Zhenfei Cai, Shenzhen (CN)

(21) Appl. No.: 16/624,394

(22) PCT Filed: Nov. 7, 2019
(86) PCT No.: PCT/CN2019/116130

§ 371 Date: Dec. 19, 2019

(30) Foreign Application Priority Data
Aug. 20, 2019 (CN) 201910768754.4

(51) Int. Cl. G09G 3/3258; G09G 3/3233; G09G 3/3291; G09G 3/34

(52) U.S. Cl. CPC G09G 3/3258; G09G 3/3233; G09G 2320/0673; G09G 3/3406; G09G 2320/0233; G09G 3/3291

(57) ABSTRACT

An image processing method of a display panel and the display panel are provided. The display panel including at least one notch edge display region makes output enable signal inputted by edge pixels located in the notch edge display region partially occlude its corresponding scan control light emitting signal, thereby realizing brightness compensation of the pixels on the notch edge display region, and further eliminating a zigzag shape problem existing in the notch edge display region.

### FIELD OF INVENTION

The present disclosure relates to the field of display technology, and particularly relates to an image processing method of a display panel and a display panel.

### BACKGROUND OF INVENTION

With rapid development of the display technology, various notch display panels are widely used in electronic equipment. Notch display panels refer to display panels having display regions with non-rectangular shapes. For display panels having display regions with non-rectangular shapes, on notch edge positions of the display regions with non-rectangular shapes, pixels are arranged along the notch edge positions to fit boundary lines of the notch edge positions better. However, as each pixel of the display panels includes a plurality of subpixels having rectangular structures, in order to ensure integrity of the plurality of subpixels, the plurality of subpixels in each pixel cannot completely match with the boundary lines on the notch edge positions, and there may be zigzag-shaped notches, which cause displayed images to have a problem of displaying zigzag shapes on the notch edge positions of the display regions, thereby further affecting visual effect of the display panels.

In summary, in current image processing methods of display panels and the display panels, because the plurality of subpixels of each pixel of the display panels and the boundary lines of the notch edge positions have zigzag-shaped notches, this causes the displayed images to have the problem of displaying zigzag shapes on the notch edge positions of the display regions, thereby further affecting the visual effect of the display panels.

In current image processing methods of display panels and the display panels, the technical problem is that because the plurality of subpixels of each pixel of the display panels and the boundary lines of the notch edge positions have zigzag-shaped notches, this causes the displayed images to have the problem of displaying zigzag shapes on the notch edge positions of the display regions, thereby further affecting the visual effect of the display panels.

The present disclosure provides an image processing method of a display panel and the display panel, which can eliminate the problem of displayed images having the problem of displaying zigzag shapes on the notch edge position of the display region, thereby solving the technical problem of current image processing methods of display panels and the display panels, that is, because the plurality of subpixels of each pixel of the display panels and the boundary lines of the notch edge positions have zigzag-shaped notches, this causes the displayed images to have the problem of displaying zigzag shapes on the notch edge positions of the display regions, thereby further affecting the visual effect of the display panels.

### SUMMARY OF INVENTION

In order to solve the problems mentioned above, the present disclosure provides technical solutions as follows:

The present disclosure provides an image processing method of a display panel, the method includes:

S10: providing a display panel having at least one notch edge display region. Edge pixels are located in the notch edge display region and inputted an output enable signal, a first scan control light emitting signal, and a data signal. Furthermore, the first scan control light emitting signal controls the data signal to correspondingly output a first gamma voltage group on the edge pixels.

S20: partially occluding the first scan control light emitting signal by the output enable signal, and outputting a second scan control light emitting signal. The second scan control light emitting signal controls the data signal to correspondingly output a second gamma voltage group on the edge pixels.

S30: the display panel displaying images on the notch edge display region based on a value of the second gamma voltage group.

In the image processing method of the display panel provided on an embodiment of the present disclosure, in S10, an edge shape of the notch edge display region is a round corner.

In the image processing method of the display panel provided on an embodiment of the present disclosure, in S10, gamma voltage values outputted by the first gamma voltage group on each pixel row of the edge pixels are same.

In the image processing method of the display panel provided on an embodiment of the present disclosure, in S20, gamma voltage values outputted by the second gamma voltage group on each pixel row of the edge pixels are different.

In the image processing method of the display panel provided on an embodiment of the present disclosure, S20 includes:

S201: in the notch edge display region, partially occluding the first scan control light emitting signal corresponding to the plurality of the edge pixels by the output enable signal. Furthermore, occluding pulse widths of the first scan control light emitting signal corresponding to different rows of the edge pixels are different.

S202: performing logic operation on the output enable signal and the first scan control light emitting signal corresponding to each row of the edge pixels, and outputting the second scan control light emitting signal corresponding to each row of the edge pixels. The second scan control light emitting signal correspondingly outputs the second gamma voltage group on the edge pixels.

In the image processing method of the display panel provided on an embodiment of the present disclosure, the display panel includes a pixel driving circuit. The pixel driving circuit includes a first thin film transistor (T1), a second thin film transistor (T2), a third thin film transistor (T3),a storage capacitor (C1), an organic light emitting diode (OLED), a data signal end (Data), a scan control light emitting signal end (EM), a voltage power supply (VDD), and a negative power supply (VSS).

In the image processing method of the display panel provided on an embodiment of the present disclosure, a source electrode of the first thin film transistor (T1) is electrically connected to the voltage power supply (VDD), a gate electrode the first thin film transistor (T1) is electrically connected to the scan control light emitting signal end (EM), a drain electrode of the first thin film transistor (T1) is electrically connected to a source electrode of the second thin film transistor (T2), a gate electrode of the second thin film transistor (T2) is electrically connected to a drain electrode of the third thin film transistor (T3) and the storage capacitor (C1), a drain electrode of the second thin film transistor (T2) is electrically connected to the storage capacitor (C1) and an anode of the organic light emitting diode (OLED), a source electrode of the third thin film transistor (T3) is electrically connected to the data signal end (Data), and a cathode of the organic light emitting diode (OLED) is electrically connected to the negative power supply (VSS).

The present disclosure further provides a display panel. The display panel includes a display region and a non-display region adjacent to the display region. The display region includes at least one notch edge region. The notch edge region includes a plurality of edge pixels. Furthermore, an output enable signal and a scan control light emitting signal are inputted in the notch edge region of the display panel, and the output enable signal partially occludes the scan control light emitting signal corresponding to a plurality of rows of the edge pixels.

In the display panel provided by an embodiment of the present disclosure, an edge shape of the notch edge display region is a round corner.

In the display panel provided by an embodiment of the present disclosure, the display panel includes a pixel driving circuit, the pixel driving circuit includes a first thin film transistor (T1), a second thin film transistor (T2), a third thin film transistor (T3), a storage capacitor (C1), an organic light emitting diode (OLED), a data signal end (Data), a scan control light emitting signal end (EM), a voltage power supply (VDD), and a negative power supply (VSS). Furthermore, a source electrode of the first thin film transistor (T1) is electrically connected to the voltage power supply (VDD), a gate electrode of the first thin film transistor (T1) is electrically connected to the scan control light emitting signal end (EM), a drain electrode of the first thin film transistor (T1) is electrically connected to a source electrode of the second thin film transistor (T2), a gate electrode of the second thin film transistor (T2) is electrically connected to a drain electrode of the third thin film transistor (T3) and the storage capacitor (C1), a drain electrode of the second thin film transistor (T2) is electrically connected to the storage capacitor (C1) and an anode of the organic light emitting diode (OLED), a source electrode of the third thin film transistor (T3) is electrically connected to the data signal end (Data), and a cathode of the organic light emitting diode (OLED) is electrically connected to the negative power supply (VSS).

The beneficial effect of the present disclosure is that the image processing method of the display panel and the display panel provided by the present disclosure make the inputted output enable signal partially occlude the scan control light emitting signal corresponding to the plurality of edge pixel rows in the notch edge display region, thereby realizing brightness compensation of the pixels on the notch edge display region, and further eliminating the zigzag shape problem existing in the notch edge display region.

### DESCRIPTION OF DRAWINGS

To more clearly illustrate embodiments or the technical solutions of the present disclosure, the accompanying figures of the present disclosure required for illustrating embodiments or the technical solutions of the present disclosure will be described in brief. Obviously, the accompanying figures described below are only part of the embodiments of the present disclosure, from which those skilled in the art can derive further without making any inventive efforts.

FIG. 1 is a flowchart of an image processing method of a display panel of the present disclosure.

FIG. 2 is a schematic diagram of part of electrical signals in the image processing method of the display panel in the present disclosure.

FIG. 3 is a pixel circuit diagram of the image processing method of the display panel in the present disclosure.

### DETAILED DESCRIPTION OF PREFERRED EMBODIMENTS

The descriptions of embodiments below refer to accompanying drawings in order to illustrate certain embodiments which the present disclosure can implement. The directional terms of which the present disclosure mentions, for example, “top”, “bottom”, “upper”, “lower”, “front”, “rear”, “left”, “right”, “inside”, “outside”, “side”, etc., only refer to directions of the accompanying figures. Therefore, the used directional terms are for illustrating and understanding the present disclosure, but not for limiting the present disclosure. In the figures, units with similar structures are indicated by the same reference numerals.

The present disclosure aims at current image processing methods of display panels and the display panels. Because a plurality of subpixels of each pixel of the display panel and a boundary line of a notch edge position have zigzag-shaped notches, this causes the displayed images to have the problem of displaying zigzag shapes on the notch edge position of the display region, thereby further affecting the visual effect of the display panel, and the present disclosure can solve this defect.

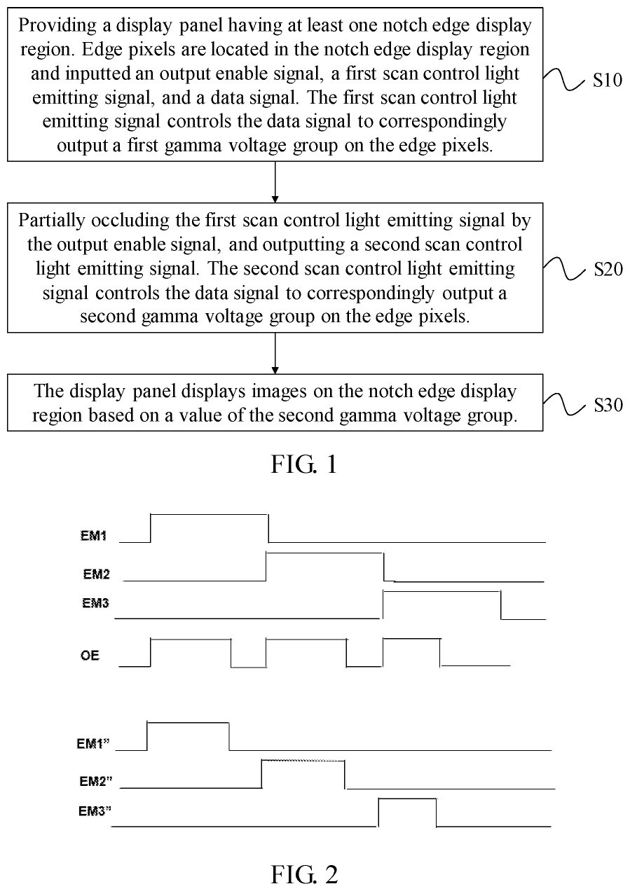

Illustrated in FIG. 1 is a flowchart of an image processing method of a display of the present disclosure. The method includes:

S10: providing a display panel having at least one notch edge display region. Each pixel is located in the notch edge display region and is inputted an output enable signal, a first scan control light emitting signal, and a data signal. Furthermore, the first scan control light emitting signal controls the data signal to correspondingly output a first gamma voltage group on the edge pixels.

Specifically, S10 further includes:

firstly, providing a display panel having at least one notch edge display region, and a plurality of pixels are disposed in the display region of the display panel. A switch element is disposed on each pixel. Each switch element is connected to a scanning line and a data line. The switch element is turned on by receiving a scanning signal from the scanning line, and drives the pixels to display a certain of grayscale by receiving the data signal of the data line. The different pixels of switch elements are connected to the scanning lines and the data lines in different combinations, so that each pixel can emit light independently.

Specifically, a plurality of edge pixels are disposed in the notch edge display region, and an edge shape of the notch edge display region is a round corner. In the notch edge display region of the edge pixels, an output enable signal (OE), a first scan control light emitting signal (EM), and a data signal (Data) are inputted. The output enable signal (OE) is generated by a time schedule controller. The first scan control light emitting signal (EM) controls the data signal (Data) to correspondingly output a first gamma voltage group on the edge pixels.

Specifically, gamma voltage values outputted by the first gamma voltage group on each pixel row of the edge pixels are same.

S20: partially occluding the first scan control light emitting signal (EM) by the output enable signal (OE), and outputting a second scan control light emitting signal (EM″). The second scan control light emitting signal (EM″) controls the data signal (Data) to correspondingly output a second gamma voltage group on the edge pixels.

Specifically, S20 further includes:

firstly, in the notch edge display region, partially occluding the first scan control light emitting signal (EM) corresponding to the plurality of the edge pixels by the output enable signal (OE). Furthermore, occluding pulse widths of the first scan control light emitting signal (EM) corresponding to different rows of the edge pixels are different. A number of the occluding pulse widths is determined according to a curvature of the notch edge display region. After that, performing logic operation on the output enable signal (OE) and the first scan control light emitting signal (EM) corresponding to each row of the edge pixels, and outputting the second scan control light emitting signal (EM″) corresponding to each row of the edge pixels. Furthermore, the second scan control light emitting signal (EM″) correspondingly outputs the second gamma voltage group on the edge pixels. Gamma voltage values outputted by the second gamma voltage group on each pixel row of the edge pixels are different. A level of the second gamma voltage group is determined according to the curvature of the notch edge display region.

S30: the display panel displays images on the notch edge display region based on a value of the second gamma voltage group.

Specifically, S30 further includes:

the display panel displays images on the notch edge display region based on a value of the second gamma voltage group. By compensating the gamma voltage to the edge pixels located on the notch edge display region, this makes an edge position of the notch edge display region be excessive smooth, thereby further eliminating the zigzag shape problem of the display panel.

Illustrated in FIG. 2 is a schematic diagram of part of electrical signals in the image processing method of the display panel in the present disclosure. The first scan control light emitting signal (EM) includes a first scan control first row light emitting signal (EM1), a first scan control second row light emitting signal (EM2), and a first scan control third row light emitting signal (EM3). After the first scan control first row light emitting signal (EM1) is occluded by the output enable signal (OE), a second scan control first row light emitting signal (EM1″) is outputted. After the first scan control second row light emitting signal (EM2) is occluded by the output enable signal (OE), a second scan control second row light emitting signal (EM2″) is outputted. After the first scan control third row light emitting signal (EM3) is occluded by the output enable signal (OE), a second scan control third row light emitting signal (EM3″) is outputted.

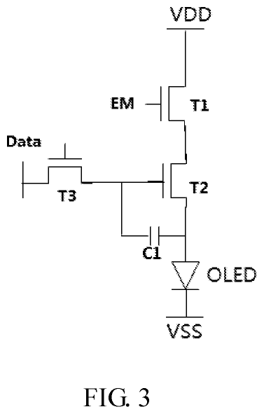

Illustrated in FIG. 3 is a pixel circuit diagram of the image processing method of the display panel in the present disclosure.

The display panel further includes a pixel driving circuit. The pixel driving circuit includes a first thin film transistor (T1), a second thin film transistor (T2), a third thin film transistor (T3), a storage capacitor (C1), an organic light emitting diode (OLED), a data signal end (Data), a scan control light emitting signal end (EM), a voltage power supply (VDD), and a negative power supply (VSS).

Specifically, a source electrode of the first thin film transistor (T1) is electrically connected to the voltage power supply (VDD), a gate electrode of the first thin film transistor (T1) is electrically connected to the scan control light emitting signal end (EM), a drain electrode of the first thin film transistor (T1) is electrically connected to a source electrode of the second thin film transistor (T2), a gate electrode of the second thin film transistor (T2) is electrically connected to a drain electrode of the third thin film transistor (T3) and the storage capacitor (C1), a drain electrode of the second thin film transistor (T2) is electrically connected to the storage capacitor (C1) and an anode of the organic light emitting diode (OLED), a source electrode of the third thin film transistor (T3) is electrically connected to the data signal end (Data), and a cathode of the organic light emitting diode (OLED) is electrically connected to the negative power supply (VSS).

The present disclosure further provides a display panel. The display panel includes a display region and a non-display region adjacent to the display region. The display region includes at least one notch edge region, and the notch edge region includes a plurality of edge pixels. Furthermore, an output enable signal and a scan control light emitting signal are inputted in the notch edge region of the display panel, and the output enable signal partially occludes the scan control light emitting signal corresponding to a plurality of rows of the edge pixels.

Specifically, an edge shape of the notch edge display region is a round corner.

Specifically, the display panel includes a pixel driving circuit. The pixel driving circuit includes a first thin film transistor (T1), a second thin film transistor (T2), a third thin film transistor (T3), a storage capacitor (C1), an organic light emitting diode (OLED), a data signal end (Data), a scan control light emitting signal end (EM), a voltage power supply (VDD), and a negative power supply (VSS). Furthermore, a source electrode of the first thin film transistor (T1) is electrically connected to the voltage power supply (VDD), a gate electrode of the first thin film transistor (T1) is electrically connected to the scan control light emitting signal end (EM), a drain electrode of the first thin film transistor (T1) is electrically connected to a source electrode of the second thin film transistor (T2), a gate electrode of the second thin film transistor (T2) is electrically connected to a drain electrode of the third thin film transistor (T3) and the storage capacitor (C1), a drain electrode of the second thin film transistor (T2) is electrically connected to the storage capacitor (C1) and an anode of the organic light emitting diode (OLED), a source electrode of the third thin film transistor (T3) is electrically connected to the data signal end (Data), and a cathode of the organic light emitting diode (OLED) is electrically connected to the negative power supply (VSS).

The beneficial effect of the present disclosure is that the image processing method of the display panel and the display panel provided by the present disclosure make the inputted output enable signal partially occlude the scan control light emitting signal corresponding to the plurality of edge pixel rows in the notch edge display region, thereby realizing brightness compensation of the pixels on the notch edge display region, and further eliminating the zigzag shape problem existing in the notch edge display region.

In summary, although the present disclosure has disclosed the preferred embodiments as above, however the above-mentioned preferred embodiments are not to limit to the present disclosure. A person skilled in the art can make any change and modification, therefore the scope of protection of the present disclosure is subject to the scope defined by the claims.

What is claimed is:

1. An image processing method of a display panel, wherein the method comprises:
providing a display panel having at least one notch edge display region, wherein edge pixels are located in the at least one notch edge display region, and are inputted an output enable signal, a first scan control light emitting signal, and a data signal, and the first scan control light emitting signal controls the data signal to correspondingly output a first gamma voltage group on the edge pixels;
partially occluding the first scan control light emitting signal by the output enable signal, and outputting a second scan control light emitting signal, wherein the second scan control light emitting signal controls the data signal to correspondingly output a second gamma voltage group on the edge pixels; and
the display panel displaying images on the at least one notch edge display region based on a value of the second gamma voltage group.

2. The image processing method of the display panel as claimed in claim 1, wherein in the step of providing the display panel having the at least one notch edge display region, an edge shape of the at least one notch edge display region is a round corner.

3. The image processing method of the display panel as claimed in claim 1, wherein in the step of providing the display panel having the at least one notch edge display region, gamma voltage values outputted by the first gamma voltage group on each pixel row of the edge pixels are same.

4. The image processing method of the display panel as claimed in claim 1, wherein in the step of partially occluding the first scan control light emitting signal by the output enable signal, and outputting the second scan control light emitting signal, gamma voltage values outputted by the second gamma voltage group on each pixel row of the edge pixels are different.

5. The image processing method as claimed in claim 1, wherein the step of partially occluding the first scan control light emitting signal by the output enable signal, and outputting the second scan control light emitting signal comprises:
in the at least one notch edge display region, partially occluding the first scan control light emitting signal corresponding to the plurality of edge pixels by the output enable signal, wherein occluding pulse widths of the first scan control light emitting signal corresponding to different rows of the edge pixels are different; and
performing logic operation on the output enable signal and the first scan control light emitting signal corresponding to each row of the edge pixels, and outputting the second scan control light emitting signal corresponding to each row of the edge pixels, wherein the second scan control light emitting signal correspondingly outputs the second gamma voltage group on the edge pixels.

6. The image processing method of the display panel as claimed in claim 1, wherein the display panel comprises a pixel driving circuit, the pixel driving circuit comprises a first thin film transistor, a second thin film transistor, a third thin film transistor, a storage capacitor, an organic light emitting diode, a data signal end, a scan control light emitting signal end, a voltage power supply, and a negative power supply.

7. The image processing method of the display panel as claimed in claim 6, wherein a source electrode of the first thin film transistor is electrically connected to the voltage power supply, a gate electrode the first thin film transistor is electrically connected to the scan control light emitting signal end, a drain electrode of the first thin film transistor is electrically connected to a source electrode of the second thin film transistor, a gate electrode of the second thin film transistor is electrically connected to a drain electrode of the third thin film transistor and the storage capacitor, a drain electrode of the second thin film transistor is electrically connected to the storage capacitor and an anode of the organic light emitting diode, a source electrode of the third thin film transistor is electrically connected to the data signal end, and a cathode of the organic light emitting diode is electrically connected to the negative power supply.

8. A display panel, wherein the display panel comprises a display region and a non-display region adjacent to the display region, the display region comprises at least one notch edge region, and the at least one notch edge region comprises a plurality of edge pixels, wherein an output enable signal and a scan control light emitting signal are inputted in the at least one notch edge region of the display panel, and the output enable signal partially occludes the scan control light emitting signal corresponding to a plurality of rows of the edge pixels.

9. The display panel as claimed in claim 8, wherein an edge shape of the at least one notch edge display region is a round corner.

10. The display panel as claimed in claim 8, wherein the display panel comprises a pixel driving circuit, the pixel driving circuit comprises a first thin film transistor, a second thin film transistor, a third thin film transistor, a storage capacitor, an organic light emitting diode, a data signal end, a scan control light emitting signal end, a voltage power supply, and a negative power supply, wherein a source electrode of the first thin film transistor is electrically connected to the voltage power supply, a gate electrode of the first thin film transistor is electrically connected to the scan control light emitting signal end, a drain electrode of the first thin film transistor is electrically connected to a source electrode of the second thin film transistor, a gate electrode of the second thin film transistor is electrically connected to a drain electrode of the third thin film transistor and the storage capacitor, a drain electrode of the second thin film transistor is electrically connected to the storage capacitor and an anode of the organic light emitting diode, a source electrode of the third thin film transistor is electrically connected to the data signal end, and a cathode of the organic light emitting diode is electrically connected to the negative power supply.
